(19) United States
(12) Patent Application Publication
(10) Pub. No.: US 2026/0220634 A1
(43) Pub. Date: Jul. 30, 2026

(54) SYSTEM AND METHOD FOR MICROMOBILITY SERVICES

(71) Applicant: SCOOTY Mobility Inc., Toronto (CA)

(72) Inventors: Shoaib Ahmed, Toronto (CA); Shahid Wajid Pasha, Toronto (CA); Moaz Yusuf Ahmad, Toronto (CA); Yashin Dipak Shah, Toronto (CA); Muhammad Wasif Khan, Toronto (CA); Pranav Srinivas Balakrishnan, Toronto (CA); Osama Ahmed, Toronto (CA); Ilya Peskov, Toronto (CA); Tariq Mushtaq Ahmed, Toronto (CA)

(73) Assignee: SCOOTY Mobility Inc., Toronto (CA)

(21) Appl. No.: 19/376,735

(22) Filed: Oct. 31, 2025

Related U.S. Application Data
(60) Provisional application No. 63/749,598, filed on Jan. 25, 2025.

(51) Int. Cl. G06Q 20/40

(52) U.S. Cl. CPC G06Q 20/401

(57) ABSTRACT

What is disclosed is: A method to integrate a first payment subsystem and a second payment subsystem, wherein: the first payment subsystem is associated with a transportation processing subsystem, the second payment subsystem is associated with a micromobility management subsystem, and an application programming interface (API) communicatively coupled to the micromobility management subsystem and the transportation processing subsystem, further wherein the API comprises: a validation unit, a gateway, and a decision engine; the method comprising: receiving, by the gateway, one or more payment card identifiers and a timestamp related to a transaction, posting, by the gateway, the transaction, validating, by the decision engine, the transaction, and based on the validating, the decision engine either approves or rejects the transaction.

### FIELD OF THE INVENTION

The present disclosure relates to micromobility services.

### BRIEF SUMMARY

A system to integrate a first payment subsystem and a second payment subsystem, wherein: the first payment subsystem is associated with a transportation processing subsystem, the second payment subsystem is associated with a micromobility management subsystem, and the micromobility management subsystem and transportation processing subsystem are communicatively coupled with each other via a network; the system comprising: an application programming interface (API) communicatively coupled to the micromobility management subsystem and the transportation processing subsystem, further wherein the API comprises: a validation unit, a gateway, and a decision engine communicatively coupled to each other; the gateway receives one or more payment card identifiers and a timestamp related to a transaction; the gateway posts the transaction; the decision engine validates the transaction; and the decision engine either approves or rejects the transaction based on the validating.

A method to integrate a first payment subsystem and a second payment subsystem, wherein: the first payment subsystem is associated with a transportation processing subsystem, the second payment subsystem is associated with a micromobility management subsystem, and an application programming interface (API) communicatively coupled to the micromobility management subsystem and the transportation processing subsystem, further wherein the API comprises: a validation unit, a gateway, and a decision engine; the method comprising: receiving, by the gateway, one or more payment card identifiers and a timestamp related to a transaction, posting, by the gateway, the transaction, validating, by the decision engine, the transaction, and based on the validating, the decision engine either approves or rejects the transaction.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 illustrates one example embodiment of a system for micromobility services.

FIG. 2 illustrates one example embodiment of a user device.

FIG. 3A illustrates one example embodiment of a micromobility management subsystem.

FIG. 3B illustrates one example embodiment of an application programming interface.

FIG. 3C illustrates one example embodiment of an universal hub implemented externally to the micromobility management subsystem.

FIG. 3D illustrates one example embodiment of an universal hub implemented internally to the micromobility management subsystem.

FIG. 4A illustrates one example embodiment of a process for a new user to validate and add a payment card.

FIG. 4B illustrates one example embodiment of a process for renting a micromobility vehicle within a single-mode trip.

FIG. 4C illustrates one example embodiment of payment using a payment mechanism.

FIG. 5 illustrates one example embodiment of a process for renting a micromobility vehicle within a multimode trip.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

Micromobility services have the potential to cut the congestion, emissions and noise pollution that plague modern cities. Micromobility services also represent a real and tangible solution to the first- and last-mile transportation gap. Providing micromobility vehicles for rental or shared micromobility services can enable urban populations to enjoy micromobility solutions to fulfil their first- and last-mile transportation needs.

For micromobility to move into the mainstream, a deeper understanding of users, non-users and their needs is essential.

For micromobility service providers to enhance their revenue and impact, it is essential that the services they provide are integrated with other transportation systems, municipalities, housing authorities, community organizations and non-profit organizations.

Integration of transportation systems with micromobility services enables interoperability, which in turn enables efficiencies to be unlocked as well as an improved user experience.

Users experience higher convenience when transportation systems are integrated with micromobility services. For example, when users can use the payment subsystem provided by the transportation system to pay for micromobility vehicle rental, it improves convenience. A specific example: the METROLINX® PRESTO® subsystem allows a user to pay fares on transportation systems in Southern and Eastern Ontario such as the GO® Transit transportation system, the Toronto Transit Commission (TTC) system and the MiWay transportation system. When users of these transportation systems can use the METROLINX® PRESTO® payments subsystem to pay for renting micromobility vehicles from providers such as SCOOTY, it improves convenience for these users.

Integration enables users to more easily schedule multimodal trips where at least one of the modes involves a rented micromobility vehicle. For example, a user travelling from Toronto to Brampton by GO® train can reserve a micromobility vehicle for the first or last leg of their journey. Then, when the user arrives at Brampton GO® train station, the micromobility vehicle is ready for the user to seamlessly pick up and use as needed.

Furthermore, micromobility vehicles have the potential to reduce carbon emissions and thereby reduce carbon footprint. Enabling integration with transportation systems makes it even more likely that a user will utilize a rented or shared micromobility vehicle to make the journey, thereby reducing the impact on the environment. This also has the impact of reducing traffic congestion in urban areas.

Integration may also afford opportunities to improve urban planning, development and land-use. Integration may also provide increased flexibility and adaptiveness of capacity and services to meet the dynamic needs of riders.

As was explained before, when payment subsystems or mechanisms associated with transportation systems are integrated with the payment subsystems or mechanisms associated with micromobility service providers, this improves user convenience greatly.

Two types of payment subsystems or mechanisms in transportation systems are closed-loop and open-loop payment subsystems or mechanisms. A closed-loop payment subsystem or mechanism is one where: the transit operator, agency or authority accepts payment using proprietary arrangements such as payment cards or applications on smart devices, which are specifically issued by the transit operator, agency or authority. In contrast, open-loop payment subsystems or mechanisms enable transit operators or authorities to accept payments from customers using non-proprietary arrangements such as financial institution payment cards, or applications or mobile wallets on smart devices, regardless of which financial institution each party banks with. This eliminates the need for separate transit-authority-specific cards or tickets.

Closed loop payment subsystems provide certain advantages over open loop payment subsystems. For example, closed loop payment subsystems provide transit authorities or agencies with enhanced and customized data collection and control over data collected, when compared to an open loop payment subsystem as well as financial benefits for end users such as fare subsidies. Open loop payment subsystems may offer less control over user data to the transit authority or agency and may not offer financial incentives.

Closed loop payment subsystems may also offer more control over transactions compared to open loop subsystems. Different types of discounts, caps and arrangements are more easily facilitated with closed loop subsystems compared to open loop subsystems.

However, closed loop payment subsystems face drawbacks. Closed loop payment subsystems may require that the transit agency or authority provides its own devices to validate, secure and manage payment card values. Also, the payment subsystem is specific to that transit authority, thereby limiting interoperability with other payment subsystems.

From the point of view of a micromobility and/or other third-party mobility services provider, integration with a closed loop payments subsystem enables access to potentially higher quality data, which in turn allows for service which is more customized to an individual user. However, integration with closed loop payments subsystems may be more complex and lead to scalability challenges for micromobility services providers, since each closed loop payments subsystem is likely to be custom-built and may use proprietary components.

Then, there is a need for micromobility services which enable users to rent or access shared micromobility vehicles in a more convenient and seamless way. The micromobility services need to be integrated with other transportation systems, so that users can enjoy benefits and efficiencies due to integration explained above. Specifically, the micromobility services should have associated payment subsystems or mechanisms which are integrated with payment subsystems or mechanisms used in transportation systems, especially closed-loop payment subsystems, to deliver the above-described benefits.

These services should be synchronized with urban planning so as to reduce traffic congestion, reduce greenhouse gas (GHG) emissions, and improve mobility and safety. The services should be integrated with different land-uses, such as commercial centres, offices and business parks, warehouses, institutions, and residential areas/developments. Integration is especially important around zones which are:

large trip generators, that is, where a high volume of trips is generated,

those in higher density areas, and

those in close proximity to transit stations, for example, within a 1-3 km radius of a transit station.

Such integration helps support various policies and plans of governments at all levels.

There is also a need to offer on-demand, customizable routes, and freedom of movement, thereby allowing users to travel to their destination in the most efficient, or convenient, or interesting, or safest way possible. The services should use multiple sources of information and data to guide the rider towards their best and/or safest ride option to get to their destination. Other useful features include suggestions of options for riders to take side trips or make stops at points of interest.

Micromobility services also need to maintain capacity to meet the dynamic needs of riders. The services should also be flexible so as to respond to large increases or decreases in demand and travel patterns, such as a major traffic incident or major event.

Prior art and prior use works do not address these challenges adequately. For example, United States Patent Application 2022/0164747 to Shah et al, filed November 20, 2020, published on May 26, 2022 and hereinafter referred to as “Shah”, describes a shared micromobility transit vehicle service with multimodal route planning and mapping. However, Shah does not contemplate integration of the payment mechanisms or subsystems as described above.

Patent Cooperation Treaty Application Publication WO2019135186A1 to McDowell et al, filed January 2, 2019, published on July 11, 2019 and hereinafter referred to as “McDowell”, discloses a comprehensive transportation application tailored to a user's context, with the aim of creating a "one stop shop" for travel, encouraging users to stay within the application. McDowell also discloses calculation of ticket prices and a single fare with different portions. However, McDowell does not contemplate integrated payment mechanisms or subsystems or other features relevant to shared micromobility services.

Other works of prior art such as:

United States Patent Application 2023/0236033 to Simoudis et al, filed March 30, 2023, published on July 27, 2023 and hereinafter referred to as “Simoudis”;

United States Patent Application 2021/0192584 to Spielman et al, filed December 19, 2019, published on June 24, 2021 and hereinafter referred to as “Spielman”; and

United States Patent Application 2020/0058065 to VanderZanden et al, filed August 19, 2019, published on February 20, 2020 and hereinafter referred to as “VanderZanden”; do not consider integration of micromobility and transit or transportation service providers payment mechanisms or subsystems.

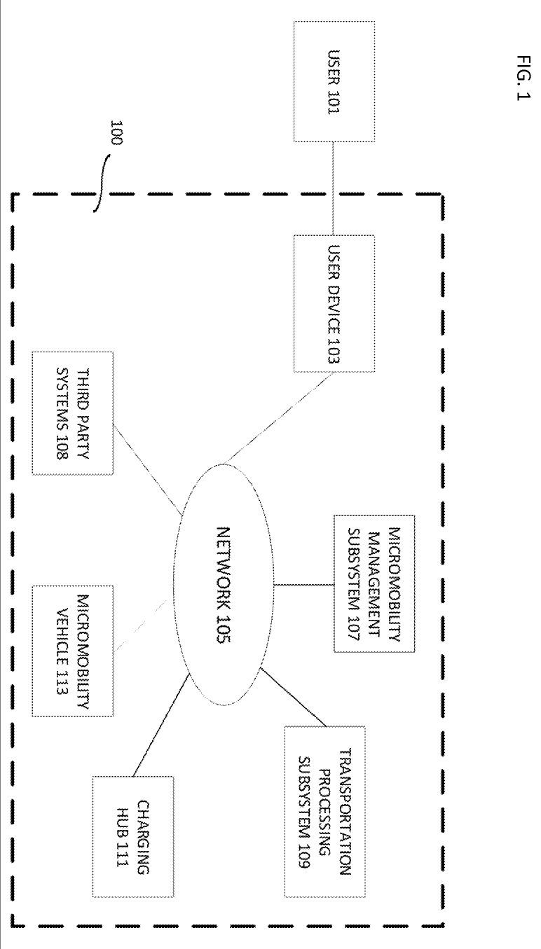

FIG. 1 shows an embodiment of a system 100 to deliver micromobility services, such as a micromobility vehicle rental service or shared micromobility vehicle service, to meet the needs described above. System 100 comprises various components as shown in FIG. 1. These components perform various functions to implement the systems and methods that are the subject of this specification.

User 101 has associated user device 103. User device 103 is, for example, a smartwatch, smartphone, tablet, laptop, or any appropriate computing and network-enabled device. User device 103 enables user 101 to couple to the various components of system 100 via network 105.

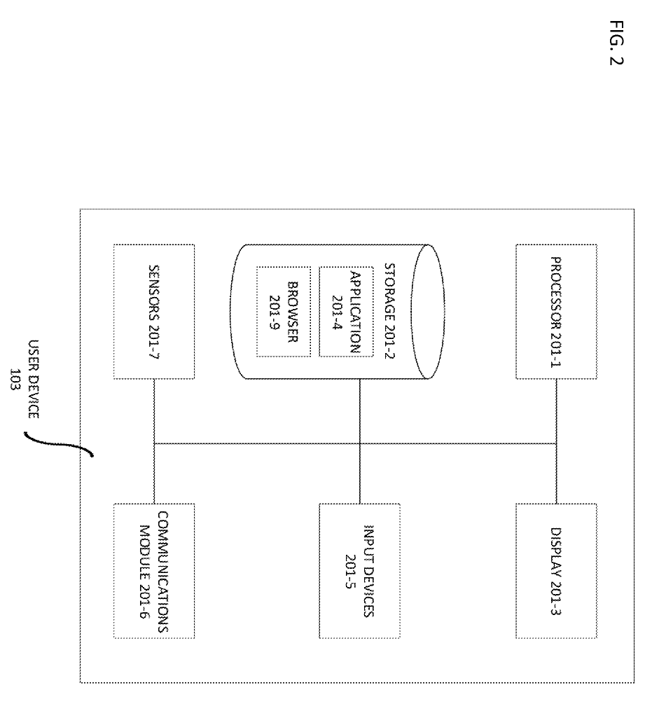

An embodiment of user device 103 is shown in FIG. 2. Processor 201-1 performs processing functions and operations necessary for the operation of user device 103, using data and programs stored in storage 201-2. Examples of such programs are application 201-4 and browser 201-9. Display 201-3 performs the function of displaying data and information for user 101. Input devices 201-5 allow user 101 to enter information. This includes, for example, devices such as a touch screen, mouse, keypad, keyboard, microphone, camera, video camera and so on. In some embodiments, display 201-3 is a touch screen which means it is also part of input devices 201-5. Communications module 201-6 allows user device 103 to communicate with devices and networks external to user device 103. This includes, for example, communications via BLUETOOTH®, Wi-Fi, Near Field Communications (NFC), Radio Frequency Identification (RFID), 3G, Long Term Evolution (LTE), Universal Serial Bus (USB) and other protocols known to those of ordinary skill in the art. The components of user device 103 are coupled to each other as shown in FIG. 2.

In some embodiments, application 201-4 enables user 101 to utilize user device 103 to communicate with the other components of system 100 to perform functions related to micromobility services and transportation services comprising, for example:

renting micromobility vehicles in different communities from their associated fleets;

reserving micromobility vehicles for rental;

planning and scheduling multimodal trips where one of the modes involves a rented micromobility vehicle;

paying for the rentals using a variety of pre-paid and post-paid purchase options and payment mechanisms including payment mechanisms utilized by other transportation systems;

viewing account details and information such as

payment history

route history,

purchase options,

user profile, which comprises information such as:

age,

gender,

profession, and

location;

usage, and

dispute or refund requests;

presenting media content of a variety of types designed for a variety of platforms and purposes, focused on communications and the delivery of information related to:

a service provider such as SCOOTY,

services offered by a provider such as SCOOTY,

operational updates,

safety,

courtesy,

partnership,

community events,

holidays, and

other topics of utility or interest.

offering rewards for frequent riders, ride discounts, promos and push notifications of preferred discounts at local businesses; and

promoting points of interest, safe or interesting routes and other ways to potentially make travel more interesting/enjoyable.

In other embodiments, user 101 utilizes browser 201-9 to access a website for micromobility services and thereby achieve their goals in the same way as application 201-4.

In some embodiments, application 201-4 is associated with a transit operator, agency or authority. Then, in some of the embodiments where there is integration between the micromobility services provider and the transit operator, agency or authority; user 101 is able to utilize application 201-4 to access micromobility services as described above. Similarly, in some embodiments user 101 utilizes browser 201-9 to access a website for the transportation system which allows the user 101 to access micromobility services similar to as described above.

In some embodiments, application 201-4 communicates with the other components of user device 103 to enable the user to access micromobility services. For example, in some embodiments, application 201-4 interacts with input devices 201-5 to enable user 101 to enter information in a variety of modes such as images, videos, text and audio. An example is where a user scans and uses a Quick Response (QR) code to start using a micromobility vehicle 113. In other embodiments, application 201-4 interacts with other data and programs stored in storage 201-2, so that user 101 can, for example:

pay for renting a micromobility vehicle 113,

schedule a single-mode or multimodal journey, or

plan and map a single-mode or multimodal journey.

In yet other embodiments, application 201-4 interacts with other programs provided by other providers to perform the functions described above and below. In some embodiments, these other programs are part of third party systems 108.

Networks 105 plays the role of communicatively coupling the various components of system 100. Networks 105 can be implemented using a variety of networking and communications technologies. In some embodiments, networks 105 are implemented using wired technologies such as Firewire, Universal Serial Bus (USB), Ethernet and optical networks. In some embodiments, networks 105 are implemented using wireless technologies such as WiFi, BLUETOOTH®, NFC, 3G, LTE and 5G. In some embodiments, networks 105 are implemented using satellite communications links. In some embodiments, the communication technologies stated above include, for example, technologies related to a local area network (LAN), a campus area network (CAN) or a metropolitan area network (MAN). In yet other embodiments, networks 105 are implemented using terrestrial communications links. In some embodiments, networks 105 comprise at least one public network. In some embodiments, networks 105 comprise at least one private network. In some embodiments, networks 105 comprise one or more subnetworks. In some of these embodiments, some of the subnetworks are private. In some of these embodiments, some of the subnetworks are public. In some embodiments, communications within networks 105 are encrypted.

Micromobility management subsystem 107 performs functions related to the management and provision of micromobility vehicle rental services or shared micromobility vehicle services for a user such as user 101.

Micromobility management subsystem 107 is used for a variety of purposes and implements a variety of functions. This comprises, for example:

Storing and analyzing data for users and other components of system 100 to access, such as:

Ride identification,

Rider identification,

Rider Name,

QR Code,

Fleet Name,

Amount,

Tax,

Duration,

Distance,

Location, and

Rating;

Generating one or more interfaces and dashboards using the stored data and the data analysis;

Providing single mode and multimodal trip planning and journey management functionalities for users which are integrated with other transportation systems;

Performing functions necessary for operations related to micromobility services comprising, for example,

deployment,

rebalancing,

collection,

maintenance, and

redeployment;

Enabling users such as user 101 to pay for micromobility services using

a variety of pre-paid, and post-paid payment options, and

a variety of payment mechanisms, including payment mechanisms of other transportation systems;

Receiving and processing reservation requests made by user 101 via, for example, application 201-4 running on user device 103, or via website accessed by browser 201-0 running on user device 103; and

Receiving and processing operations requests (e.g. starting, pausing, unpausing, ending a ride, and adding a group rider) made by user 101 via, for example, application 201-4 running on user device 103.

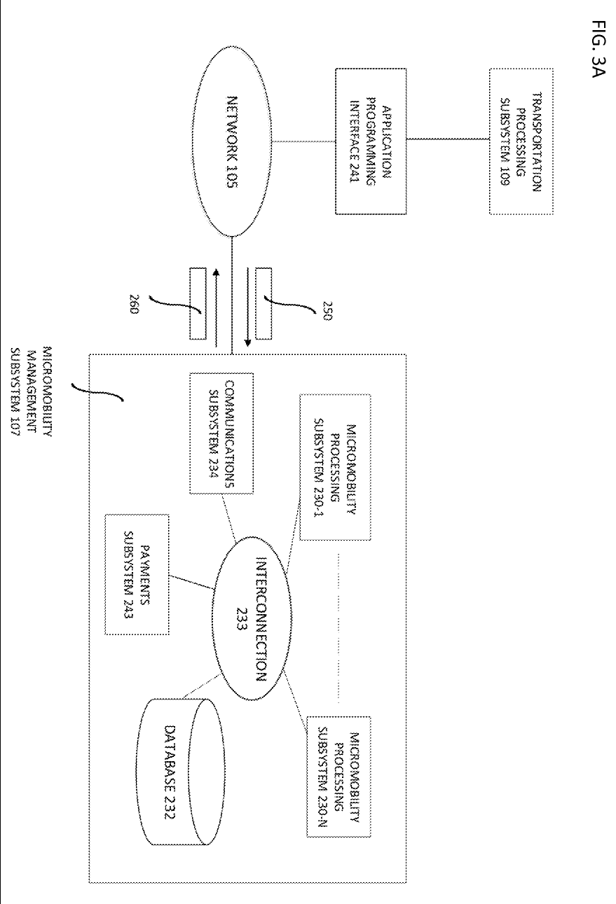

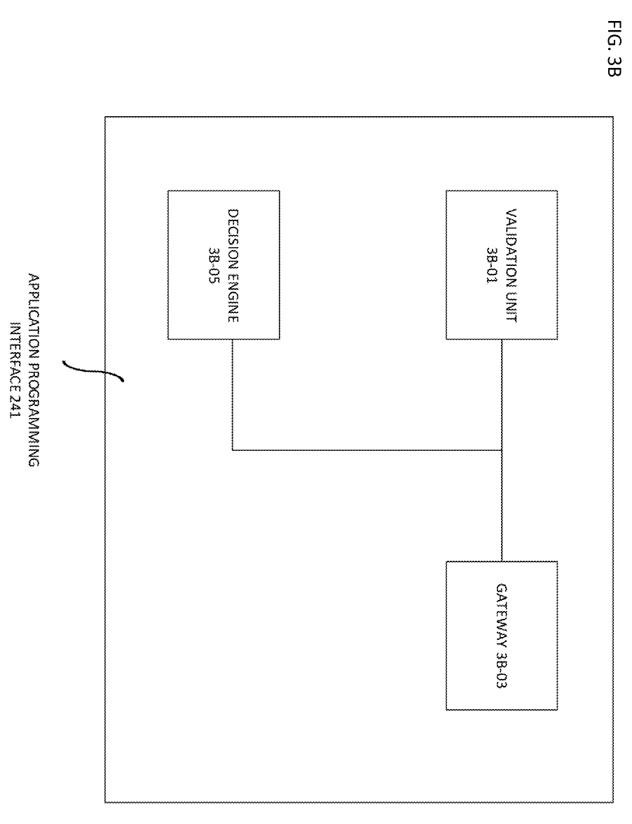

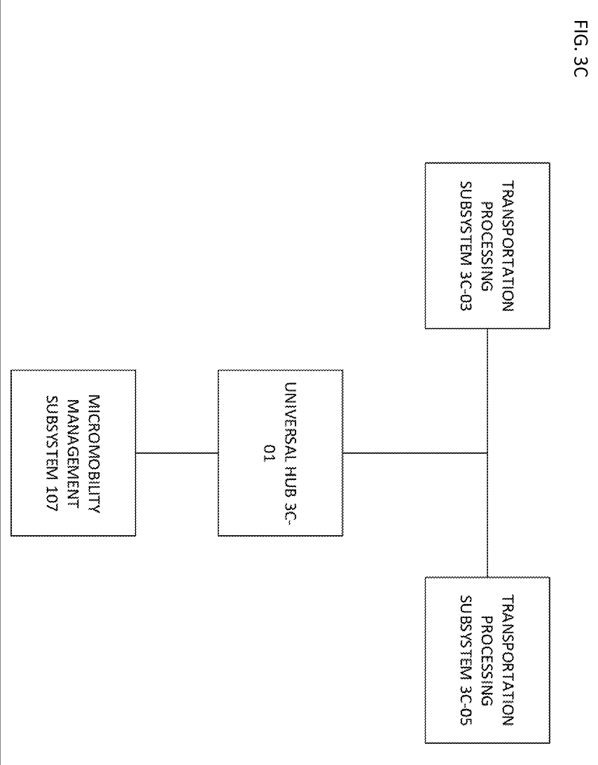

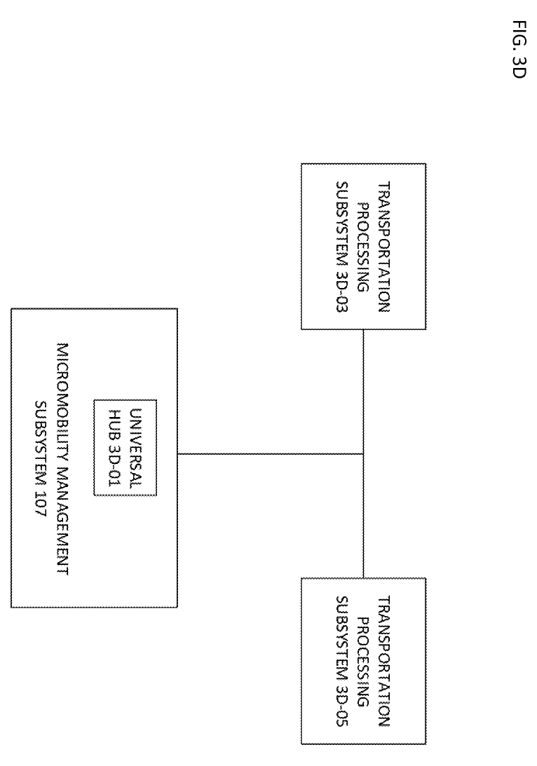

A detailed illustration of an example embodiment of micromobility management subsystem 107 is shown in FIG. 3A. In FIG. 3A, communications subsystem 234 is coupled to network 105. Communications subsystem 234 receives information from and transmits information to network 105. Communications subsystem 234 can communicate using the communications and networking protocols and techniques that network 105 utilizes. Communications subsystem 234 receives information from network 105 within, for example, incoming signals 250; and transmits information to network 105 within, for example, outgoing signals 260. Incoming signals 250 comprise, for example, data and commands transmitted from the other components of system 100 to micromobility management subsystem 107. Outgoing signals 260 comprise, for example, for example, data and commands transmitted to the other components of system 100 from micromobility management subsystem 107.

Databases 232 stores information, algorithms, programs and data for use by micromobility management subsystem 107. This comprises, for example:

one or more algorithms and programs necessary to perform the various functions performed by micromobility management subsystem 107, and

data needed for the micromobility processing subsystems 230-1 to 230-N to perform operations and functions. This comprises, for example:

vehicle ID,

ride identification,

rider identification,

ride date,

start location,

end location,

trip transfers,

amounts, and

mode of transport.

In some embodiments, database 232 further comprises a database server. The database server receives one or more commands from, for example, micromobility processing subsystems 230-1 to 230-N and communication subsystem 234, and translates these commands into appropriate database language commands to retrieve and store data into databases 232. In one embodiment, database 232 is implemented using one or more database languages known to those of ordinary skill in the art, including, for example, Structured Query Language (SQL). In a further embodiment, database 232 stores data for a plurality of users. Then, there may be a need to keep the set of data related to each user separate from the data relating to the other users. In some mbodiments, database 232 is partitioned so that data related to each user is separate from the other users. Then each user needs to authenticate themselves to access information related to their particular data sets. In a further embodiment, when data is entered into databases 232, associated metadata is added so as to make it more easily searchable. In a further embodiment, the associated metadata comprises one or more tags. In yet another embodiment, database 232 presents an interface to enable the entering of search queries. Further details of this are explained below. In some embodiments databases 232 comprises a transactional database. In other embodiments, databases 232 comprise a multitenant database.

With regard to the partitioning described above, in some embodiments each user has a separate account. In yet other embodiments, each user has a separate user wallet. Techniques to implement user accounts and wallets are known to those of ordinary skill in the art and will not be discussed further here.

Interconnection 233 connects the various components of micromobility management subsystem 107 to each other. In some embodiments, interconnection 233 is implemented using, for example, networks and communications technologies known to those in the art. These include, for example, wireless networks, wired networks, Ethernet networks, local area networks, metropolitan area networks and optical networks. In some embodiments, interconnection 233 comprises one or more subnetworks. In another embodiment, interconnection 233 comprises other technologies to communicatively couple multiple components to each other including, for example, buses, coaxial cables, USB connections and so on.

Micromobility processing subsystems 230-1 to 230-N perform processing and analysis within micromobility management subsystem 107 using one or more algorithms and programs. These algorithms and programs are stored in, for example:

database 232 as explained above, or

within micromobility processing subsystems 230-1 to 230-N.

Examples of operations performed by micromobility processing subsystem 230-1 to 230-N are explained below. In some embodiments, micromobility processing subsystem 230-1 to 230-N performs processing of commands sent by, for example, user device 103 via application 201-4 or browser 201-9. In some embodiments, the processing of commands is performed using data stored in database 232.

In some embodiments, micromobility processing subsystem 230-1 to 230-N communicates with third party systems 108 where necessary to enable micromobility management subsystem 107 to perform operations.

In some embodiments, micromobility processing subsystem 230-1 to 230-N manages the integration with other transportation systems by interfacing with the subsystems that manage those transportation systems, such as transportation processing subsystem 109.

In some embodiments, integration is facilitated using one or more application programming interfaces (APIs). The APIs can be implemented in a variety of ways. In some embodiments, the transportation processing subsystem 109 hosts and presents an API to micromobility management subsystem 107. Then, micromobility management subsystem 107 communicatively couples with the API to enable interfacing with transportation processing subsystem 109. In other embodiments, the micromobility management subsystem 107 hosts the API, and transportation processing subsystem 109 communicatively couples with the API to interface with micromobility management subsystem 107. In some embodiments, the API is implemented using a server or other suitable hardware. In yet other embodiments, the API is implemented using a combination of hardware and software. In some embodiments, the hardware comprises one or more processors. An example embodiment of an API is API 241 for payment integration, which is described in further detail below. In addition to payment integration, APIs can be used for integration of other functionalities including chat subsystem integration, navigation or mapping integration, scheduling integration and real-time transportation updates. In some embodiments, the communicative coupling is achieved via encrypted communications set up over networks 105.

In yet other embodiments, the API also integrates with one or more data feeds, such as General Transit Feed Specification (GTFS) feeds, or other feeds known to those of ordinary skill in the art. In yet other embodiments, the API is integrated with third-party services provided by, for example, third party systems 108. In yet other embodiments, a payment gateway is implemented on, for example, application 201-4, so that a user such as user 101 can access their account via an API such as API 241 to make payments.

In some embodiments, as part of the management of the integration, micromobility processing subsystem 230-1 to 230-N enables sharing of account information between the user account information held on micromobility management subsystem 107 and transportation processing subsystem 109, so that a user can view, top-up and see multimodal trip history from application 201-4.

In other embodiments, as part of the management of the integration, micromobility processing subsystem 230-1 to 230-N enables sharing of payment information through transportation processing subsystem 109 to allow communications between multiple third-party systems 108 for the purpose of payment processing and access to services provided by micromobility management subsystem 107, as well as by third party systems 108. This enables users such as user 101 to schedule, plan and pay multimodal trips with other transportation systems by communicating with the subsystems which manage the other transportation systems.

In some embodiments, micromobility processing subsystem 230-1 to 230-N interfaces with different micromobility vehicles such as micromobility vehicle 103 to perform various functions including but not limited to security, maintenance, planning and rebalancing operations. n some embodiments, micromobility processing subsystem 230-1 to 230-N interfaces with components of system 100 such as charging hub 111 to perform various functions including but not limited to security, maintenance, planning and rebalancing operations.

In some embodiments, micromobility processing subsystem 230-1 to 230-N performs artificial intelligence (AI) and machine learning (ML)-related operations such as:

pre-processing of data sets prior to performing AI or ML operations such as training and testing,

model training using training data sets,

model testing using testing data sets,

selecting appropriate models to use,

performance evaluation of different AI or ML models,

inference or prediction using trained AI or ML models, and

post-processing of data sets

In some embodiments, the AI operations comprise operations implemented using generative AI techniques. As is known to one of ordinary skill in the art, generative AI is AI that can create original content such as text, images, video, audio or software code in response to a user’s prompt or request.

In some embodiments, micromobility processing subsystem 230-1 to 230-N performs rebalancing operations comprising, for example:

Data-driven demand analysis: this comprises, for example:

Ride pattern analysis wherein historical trip data is used to identify areas with consistently high demand, and

Identification of peak times for usage of micromobility vehicles;

Time-based rebalancing: this comprises changing the distribution of micromobility vehicles to ensure sufficient supply of vehicles in areas of high demand based on the time of the day. For example, during the morning rush hour, more vehicles are positioned in residential areas near public transit hubs and locations frequented by commuters to enhance first mile and last mile connectivity.

Fleet optimization: this comprises operations such as geo-fencing to implement digital parking zones to define preferred pickup and drop off points, and

Operational and maintenance rebalancing – this comprises providing data and commands to support operations such as:

Overnight redistribution of micromobility vehicles to areas of anticipated high demand in the morning,

Collecting vehicles with low battery levels or those flagged for maintenance during low-demand hours, and

Redistributing fully charged and functional vehicles back into high-demand zones to ensure availability during peak hours.

In some embodiments, micromobility processing subsystem 230-b to 230-N communicates with the subsystems that manage other transportation systems to, for example, ensure sufficient supply of vehicles near transit hubs, and provide signage and applications to guide users towards vehicles.

In some embodiments, micromobility processing subsystem 230-1 to 230-N performs monitoring and reporting of progress of rebalancing activities, comprising activities such as:

Providing real-time dashboards, where Internet of Things (IoT) technology is used to track fleet location, individual vehicle battery status and usage,

Monitoring key performance metrics such as user satisfaction and trip completion rates, and

Collection of user feedback on vehicle availability so as to provide feedback to adjust rebalancing operations appropriately.

In some embodiments, micromobility processing subsystem 230-1 to 230-N performs dynamic pricing analysis and implementation based on system demand, micromobility vehicles 113 availability, and time of day.

In some embodiments, micromobility processing subsystem 230-1 to 230-N interacts with third party systems 108 to perform operations as needed.

In some embodiments, micromobility processing subsystem 230-1 to 230-N manages information technology (IT) components that user device 103 uses to interact with the micromobility services, such as application 201-4 and websites which are accessed from browser 201-9.

In some embodiments, micromobility processing subsystem 230-1 to 230-N performs functions necessary to enable searching of database 232 such as implementation of appropriate data search algorithms.

In some embodiments, AI and ML operations are used to assist in the performing of the functions of micromobility management subsystem 107. Examples include:

Performing analyses to assist in, and enhance deployment and rebalancing operations, where, for example, data on utilization is used to train and test data sets;

Performing image recognition to determine where micromobility vehicles have been parked to, for example, determine whether the vehicle has been parked within the vicinity of an end point;

Enabling users to plan the most efficient routes to travel from a starting point to an end point for a multimodal trip;

Enabling users to manage their journeys from a starting point to an end point for a multimodal trip;

Enabling users to understand and enhance trip connectivity, for example, offering alternative routes, predictions of times to complete legs of journeys;

Enabling transportation partners to package on-demand and/or schedule fares with trip costs and distributing the correct fare revenue to each partner;

Enabling dynamic pricing based on peak/off-peak usage and ridership demand;

Enabling implementation of chat subsystems;

Identifying any possible fraudulent activity, break, or breach in subsystem; and

Enabling streamlined automated customer support response and support handling system.

In some of the embodiments above where AI or ML is used, agentic AI is used to facilitate implementation. One of ordinary skill in the art would understand that: agentic AI systems use one or more types of AI agents that work together to achieve more complex tasks. An AI agent refers to a system or program that is capable of autonomously performing tasks on behalf of a user or another system by designing its workflow and utilizing available tools, all without human intervention. In some embodiments, AI agents are implemented using specialized hardware such as AI accelerator hardware and processing units developed by corporations such as INTEL®, NVIDIA® and AMD®. Examples include the NVIDIA H100 Tensor Core GPU. In some embodiments, the AI agents can be trained and tested using algorithms known to those of ordinary skill in the art and massive data sets.

In some embodiments, at least one AI agent is implemented within micromobility management subsystem 107 by one or more of micromobility processing subsystems 230-1 to 230-N or payments subsystem 243 in conjunction with database 232. In yet other embodiments, storage 201-2 on user device 103 stores one or more AI agents, which communicates with the AI agents implemented within micromobility management subsystem 107. In yet other embodiments, one or more AI agents on third party systems 108 work together with the AI agents implemented within micromobility management subsystem 107.

Payment subsystem or mechanism 243 performs the functions necessary to support the handling and management of payments for the micromobility management subsystem 107. In some embodiments, payment subsystem 243 works with one or more components of micromobility management subsystem 107 to perform these functions. These functions comprise, for example:

Payment processing for services provided by the micromobility provider associated with the micromobility management subsystem 107;

Payment processing for services provided by the transportation system associated with the transportation processing subsystem 109;

Interaction with, for example, payment APIs such as API 241 to ensure that payments are processed, as discussed below;

User wallet or user account management in conjunction with, for example, database 232 and micromobility processing subsystem 230-1 to 230-N; and

Interactions with third party systems 108 such as third-party payment processors and financial institutions to ensure that payments are received and processed.

In some embodiments, the functions performed by payment subsystem 243 are performed by micromobility processing subsystems 230-1 to 230-N.

As explained previously, there is a need for payment subsystem 243 to integrate with payment subsystems or mechanisms related to transportation systems, especially when those payment subsystems or mechanisms are closed-loop payment subsystems or mechanisms. As explained above, closed loop payment subsystems or mechanisms may use proprietary arrangements, which could make integration complex.

APIs offer a way to integrate closed-loop payment subsystems or mechanisms with payment mechanisms or subsystems which are associated with micromobility services. FIG. 3B describes an example embodiment of a payment API 241 in further detail. In some embodiments, the components of API 241 work together with, for example, at least one of:

the components of micromobility management subsystem 107,

transportation processing subsystem 109, and

the other components of system 100, to perform their functions.

An example embodiment of API 241 is illustrated in detail in FIG. 3B. API 241 in FIG. 3B comprises validation unit 3B-01, gateway 3B-03 and decision engine 3B-05. These components are communicatively coupled with each other using techniques known to those of ordinary skill in the art.

In FIG. 3B, validation unit 3B-01 plays the role of validating a transportation user’s payment cards. In embodiments where transportation subsystem 109 uses a closed-loop payment mechanism, validation unit 3B-01 then validates the closed-loop payment cards associated with a user. In some embodiments, this comprises the validation unit 3B-01 performing two-factor authentications (2FA) or multi-factor authentications (MFA) to perform its functions.

Gateway 3B-03 implements one or more microservices to enable functionalities comprising, for example:

payment registration,

balance retrieval,

transaction posting, and

reversal handling.

Decision engine 3B-05 applies ride fare logic, authorization rules, and fraud detection policies in real time. In some embodiments, decision engine 3B-05 performs backend synchronization with the payment subsystem or mechanism supported by transportation subsystem 109. In some embodiments, all interactions are stored in formats to enable easy auditing. In other embodiments, the decision engine 3B-05 is built to be hardware-agnostic, which enables the reuse of closed-loop payment mechanism devices for micromobility services.

In some embodiments, payment card identifiers are used to interact with the other components of API 241 to perform identity verification, dynamic fare application, secure microtransaction logging, and extensibility to backend services associated with transit implemented on, for example, transportation processing subsystem 109.

As explained above, API 241 may work together with other components of system 100 to perform tasks. In some embodiments, API 241 works together with third party systems 108 to perform tasks. An example is where one or more components of API 241 such as validation unit 3B-01 or decision engine 3B-05 work together with third party digital identity verification services such as Zumigo to perform validation tasks related to identity verification.

In some embodiments, identity verification using data obtained from one or more third-party data providers is implemented by, for example, at least one of one or more components of API 241 or micromobility management subsystem 107. The obtained data is processed using fraud detection decision logic to assess the likelihood of fraudulent activity.

When the outcome of this assessment is positive, then in some embodiments, at least one of the API or the micromobility management subsystem 107 authorizes the transaction without additional user action.

When the outcome is negative, in some embodiments at least one of the API 241 or micromobility management subsystem 107 initiates one or more secondary verification steps, such as:

Two-factor authentication (2FA) or multi-factor authentication (MFA), or

Validation of user-provided payment instrument details such as confirming the current balance of a linked transit card.

In yet other embodiments, when the outcome of the assessment is negative or an outcome associated with the secondary verification steps is negative, then at least one of the API 241 or micromobility management subsystem 107 declines the transaction and requests an alternate payment method or additional user information.

This process enables the service provider to dynamically adjust verification requirements in real time and prevent fraudulent transactions before completion.

In some embodiments, micromobility management subsystem 107 implements chat functionality via a chat subsystem. In some embodiments, this is performed by, for example, micromobility processing subsystems 230-1 to 230-N in conjunction with one or more of the other components of micromobility management subsystem 107. Examples of chat subsystems are, for example, a chatbot, or a voice-enabled assistant. In some embodiments the chat subsystem is supported by AI or ML models, such as large language models (LLM) or generative-pretrained transformers (GPT). In yet other embodiments, these AI or ML models comprise generative AI models, which have been explained above. As explained before, components within micromobility management subsystem 107 such as the micromobility processing subsystems 230-1 to 230-N implement AI-related or ML-related functions and computations. In some embodiments, these AI-related or ML-related functions and computations are used to support the chat subsystem.

In further embodiments, the chat subsystem takes multimodal inputs in one or more formats, for example:

Audio inputs, for example, via voice prompts;

Video inputs;

Documents;

Image inputs; and

Text inputs.

In some embodiments, the outputs from the chat subsystem are also multimodal. In yet other embodiments, the outputs are in a different format from the inputs. For example, in some embodiments the input to the chat subsystem is in text format, and the output is in audio or video format. In some embodiments, these multimodal outputs are generated using the above-mentioned generative AI models.

In some embodiments, the user submits inputs to the chat subsystem and receives outputs from the chat subsystem using, for example, application 201-4 running on user device 103. In some embodiments, this is used to implement an automated “ride guide” functionality on application 201-4. In some embodiments, the inputs to the chat subsystem are submitted by a user using, for example, the input devices on user device 103. In some embodiments, inputs are submitted as prompts to the chat subsystem. The submission of prompts is known to one of ordinary skill in the art. In yet other embodiments, the inputs to the chat subsystem comprise natural-language questions.

In yet other embodiments, the chat subsystem takes in inputs in one or more languages and produces outputs in one or more languages. Examples of languages include English, French, Spanish, Mandarin, Hindi, Korean, Tamil, Farsi and Arabic. In yet other embodiments, the chat subsystem comprises an auto-translate function. Implementation of translation is known to those of ordinary skill in the art and is not discussed further.

In some embodiments, the chat subsystem is optimized for micromobility vehicle riders in motion. For example, in some embodiments the voice-enabled assistant operates in “hands-free” mode.

In yet other embodiments, the chat subsystem provides one or more updates in voice mode about one or more of

transit,

navigation or mapping; and

the environment around a rider: examples include points of interest, cultural insights or eco-guides along a route

As mentioned previously, in some embodiments the chat subsystem is implemented using an API.

In some embodiments, the chat subsystem operation is based on context. For example, one or more features related to context such as location, speed and destination are determined based on inputs obtained from sources such as:

one or more of input devices 201-5 and sensors 201-7 on user device 103, or

Data feeds such as General Transit Feed Specification (GTFS) feeds, and PRESTO feeds, or

An API.

These features are then used to obtain inferences of context, which then influences the operation of the chat subsystem. For example, the chat subsystem receives location information from a GPS via an API. Based on the received location information, the chat subsystem provides voice outputs to a tourist visiting a city about major buildings that the tourist is passing.

Another example of operation based on context is as follows: a commuter is riding a micromobility vehicle towards a train station. She provides a voice input such as “Is my 3.00 bus on time” via, for example, application 201-4. The chat subsystem then works with the other components of the micromobility management subsystem 107 to determine the commuter’s context, and then works with an API query a public data feed and provide a response to the commuter via, for example, application 201-4.

In some embodiments, the above-mentioned functionalities enable the chat subsystem to provide proactive alerts such as trip tips and hazard alerts to the user.

In some embodiments, the chat subsystem works together with the payment functionality. Then, for example, a user can obtain payment-related alerts from a payment subsystem 243 and perform payment related functions using the chat subsystem.

Various implementations are possible for micromobility management subsystem 107 and its components. In some embodiments, micromobility management subsystem 107 is implemented using a cloud-based approach. In other embodiments, micromobility management subsystem 107 is implemented across one or more facilities, where each of the components are located in different facilities and interconnection 233 is then a network-based connection. In further embodiments, micromobility management subsystem 107 is implemented within a single server or computer. In yet other embodiments, micromobility management subsystem 107 is implemented in software. In other embodiments, micromobility management subsystem 107 is implemented using a combination of software and hardware. In yet other embodiments, micromobility management subsystem 107 is hosted by a cloud services provider such as AMAZON® Web Services. In yet other embodiments, micromobility management subsystem 107 is hosted on a private cloud service.

Micromobility vehicles 113 comprise lightweight vehicles suitable for personal use for transportation. Examples include but are not limited to:

bicycles,

velomobiles,

electric kick scooters or e-scooters,

electric pedal-assisted or throttle-controlled bicycles or e-bikes,

electric skateboards, and

electric motor assisted bicycles or pedelecs and e-mopeds.

Micromobility vehicle 113 can be located at various locations, for example:

Transit hubs such as bus stations, subway stations, train stations, bus stops, and tram/streetcar stops and stations;

Airports;

Retail centres;

Business and academic campuses

Ferry terminals;

Businesses and academic campuses;

Employment zones;

Residential buildings and communities; and

Recreational spaces.

Hospitality venues (i.e. hotels)

In some embodiments, micromobility vehicle 113 is equipped with a QR code to enable a user such as user 101 to scan the code using user device 103 and application 201-4 to commence a trip. In yet other embodiments, the micromobility vehicle 113 is equipped with a terminal to enable a user such as user 101 to perform an NFC “tap” payment or swipe a payment card such as a credit or debit card to initiate payment and commence a rental.

In other embodiments, micromobility vehicle 113 is docked at a docking station or charging hub 111. Then, a user such as user 101 can, for example, perform an NFC “tap” payment using a payment card or device, or swipe a credit card or other payment card to unlock and take the micromobility vehicle 113 to initiate payment and commence a rental.

In some embodiments, when a transportation subsystem such as transportation subsystem 109 is integrated with the micromobility service, then as explained above a payment card associated with transportation subsystem 109 is accepted for payment. Then the payment is handled by the combination of micromobility management subsystem 107 and transportation subsystem 109, as explained above.

In some embodiments, micromobility vehicle 113 comprises sensor technology for mapping and real-time vehicle detection and managing interactions with other road and pathway users such as other vehicles and pedestrians. In some of these embodiments, at least some of these sensors utilize Laser Imaging, Detection and Ranging (LIDAR) technology. In yet other embodiments, these sensors utilize Radio Detection and Ranging (RADAR) technology. In some embodiments, these sensors comprise sensors for:

Image capture;

Audio capture;

Measurement of environmental conditions such as temperature, pressure, sunlight and humidity; and

Video capture.

In some embodiments, data captured by the micromobility vehicle 113 is transmitted over network 105 as part of inputs to the chat subsystem implemented by micromobility management subsystem 107.

In some embodiments, micromobility vehicle 113 comprises design improvements and components to improve suitability for local environmental conditions. Examples include design improvements to handle extremely cold winters, hot summers, rain, ice, hail, freezing rain, snow and inconsistent road conditions.

In some embodiments, the design improvements are intended to improve usability and safety for riders.

In some embodiments, the design improvements are aimed at increasing ridership and improving the product lifecycle.

As explained above, micromobility vehicle 113 is communicatively coupled to micromobility management subsystem 107 so that micromobility management subsystem 107 can track micromobility vehicle 113 for security, maintenance, planning and rebalancing operations.

Transportation processing subsystem 109 performs functions related to a transportation system. Examples of transportation systems comprise:

transit systems such as

subway systems,

surface rail systems,

tram.streetcar systems, and

bus systems;

private or public on-demand transit shuttle systems;

ridesharing systems such as UBER®, LYFT® and HOPP®;

hourly rental services;

connected car services; and

long distance transportation systems including:

passenger flights,

long-distance bus services,

long-distance train services, and

chauffeured services.

Examples of functions performed by transportation processing subsystem 109 comprise:

Storing and managing data for a user such as user 101 to access and utilize the transportation system;

Managing payment subsystems and mechanisms associated with the transportation system;

Journey management, including updates;

Route planning and scheduling, including maps and updates; and

Tracking, anonymizing and aggregating data to understand ridership patterns and obtain insights about demand.

Examples of tasks related to storing and managing data for a user comprise:

Storing stored value tickets,

Determining fares,

Storing credit card information for payment of fares and tips,

Auto-loading funds from credit cards belonging to user 101 to replenish the value of a closed-loop payment card such as a stored value ticket belonging to user 101,

Storing fares paid, and

Storing and managing other information belonging to user 101 necessary to access and utilize the transportation system.

In some embodiments, one or more of these functions are performed in conjunction with third party payment processors. As will be explained below, third party payment processors fall under third party systems 108.

In some embodiments, transportation processing subsystem 109 comprises a closed-loop payment mechanism. As explained previously, in a closed-loop payment mechanism, the transit operator or authority accepts payment using proprietary arrangements. Integration with a closed-loop payment mechanism may be more challenging as explained before. However, integration may provide the micromobility service provider with higher quality data as explained before. Integration can be achieved using the API as explained previously.

In some embodiments, transportation processing subsystem 109 communicates with user device 103 via application 201-4 running on user device 103.

A variety of implementations are possible for transportation processing subsystem 109. In some embodiments, the transportation processing subsystem is implemented using a combination of hardware and software. In some other embodiments, the transportation processing subsystem is implemented using one or more servers. In some embodiments, these servers are geographically distributed.

The tasks performed as part of the journey management function relate to tasks needed to assist user 101 in planning a trip or journey. In some embodiments, user 101 accesses this functionality using application 201-4 running on user device 103. User 101 is able to, for example, check travel options available in a region of interest, see custom alerts from one or more transit agencies and purchase tickets ahead of time. In some embodiments these are multimodal trips.

Using application 201-4 or browser 201-9 on user device 103, user 101 is able to, for example, enter a starting point, end point and select criteria which best suits their needs. Examples of criteria include price, least transfers, least walking, safest route, route most suited to the mode of transportation chosen, and fastest route.

Transportation processing subsystem 109 then calculates parameters such as departure time, arrival times and journey duration in real time. This data is then transmitted to user device 103 for display via, for example, application 201-4 and display 201-3.

In a further embodiment, as part of the journey management functionalities, transportation processing subsystem 109 communicates with one or more mapping programs and services such as, for example, GOOGLE® Maps to enable user 101 to plan trips using user device 103 and application 201-4. In further embodiments, application 201-4 interacts with other applications which run on user device 103 such as GOOGLE® Maps to enable trip planning and management.

The tasks performed as part of the route planning and scheduling function relate to tasks necessary to plan different routes and create schedules within the transportation system accordingly.

Charging hub 111 allows a user 101 to charge the battery of a micromobility vehicle 113 as needed. In some embodiments, charging hub 111 is designed for 12 months of outdoor operations in variable weather conditions. In some embodiments, charging hub 111 uses one or more techniques to optimize micromobility vehicle 113 battery charging. In some other embodiments, charging hub 113 provides data to user 101 via network 105 and user device 103. In yet other embodiments, charging hub 113 couples to other sites and providers to, for example, display advertising. In yet other embodiments, charging hub 113 provides necessary information to enable micromobility management subsystem 107 to perform sustainability and environmental calculations. Examples of such calculations comprise emission calculations and environmental footprint calculations.

Third party systems 108 are systems owned by third party providers. These comprise, for example:

Systems owned by third party providers to provide advertising services;

Systems owned by municipalities, transit agencies, communities, housing providers and non-profit organizations to perform planning and management as needed;

Systems owned by third party digital identity verification providers;

Systems owned by third party providers to, for example, enable live chats, and social media interaction; and

Systems owned by third party payment processors.

In some embodiments, rather than integrating with individual transportation processing subsystems such as transportation processing subsystem 109, micromobility management subsystem 107 integrates with a universal hub, which is in turn integrated with other transportation processing subsystems.

The universal hub enables a user of a first transportation system to utilize a first payment mechanism related to the first transportation system, to pay for services on a second transportation system.

An example embodiment is shown in FIG. 3C. In FIG. 3C, universal hub 3C-01 is implemented externally to micromobility management subsystem 107, transportation processing subsystems 3C-03 and 3C-05. However, universal hub 3C-01 is integrated with micromobility management subsystem 107. Micromobility management subsystem 107 is communicatively coupled to universal hub 3C-01.

Transportation processing subsystems 3C-03 and 3C-05 manage a first transportation system and a second transportation system respectively. For example, transportation processing subsystem 3C-03 performs the role of managing a first transportation system such as Ventra Transit in Chicago. Transportation processing subsystem 3C-05 manages a second transportation system such as METROLINX PRESTO. Then in FIG. 3C, universal hub 3C-01 is implemented separately from transportation processing subsystems 3C-03 and 3C-05, but in turn communicatively coupled to and integrated with transportation processing subsystems 3C-03 and 3C-05.

In some embodiments, one or more of these integrations are performed using APIs such as API 241 in FIG. 3B, as previously discussed.

The universal hub 3C-01 performs the functions necessary to enable payments to be directed from, for example, an account or store of value in the first payment mechanism or subsystem in the first transportation processing subsystem, to the second payment mechanism or subsystem associated with the second transportation processing subsystem to pay for services. These functions comprise for example:

Currency conversion, for example, when the first payment mechanism works in a first currency and the second payment mechanism works using a second currency;

Monitoring of account values;

Operations necessary to ensure payment transfer between payment mechanisms; and

Management of an application or website which interfaces with the universal hub and which runs on a user device, such as user device 103.

The universal hub is especially useful when transit authorities or operators in different cities utilize closed-loop payment systems, and visitors to one city from another city want to use their account or stored funds in the first closed-loop payment system; to pay for services in the second closed-loop payment system.

An example is as follows: as explained above transportation processing subsystem 3C-03 performs the role of managing Ventra Transit in Chicago; and transportation processing subsystem 3C-05 manages a second transportation system such as METROLINX® PRESTO®. Since micromobility management subsystem 107 is integrated with the universal hub 3C-01, a Ventra Transit user can sign up for the micromobility service provider, so that: when the Ventra Transit user visits Toronto, they are able to utilize their Ventra Transit account to pay for services on GO Transit by interfacing with micromobility management subsystem 107 via, for example application 201-4 or browser 201-9 running on user device 103.

The micromobility management subsystem 107 then interacts with the universal hub 3C-01 to deduct funds from the visitor’s Ventra Transit account to pay for services on GO Transit. When the visitor from Chicago wants to access micromobility services, the micromobility management subsystem 107 works together with the universal hub 3C-01 to facilitate payments from a payment mechanism or subsystem associated with transportation processing subsystem 3C-03.

Using these arrangements enable the Ventra Transit user to pay for a multimodal trip such as a GO Transit journey combined with an e-scooter journey utilizing their Ventra Transit account. This is particularly useful to enable interoperability when the user is part of a transportation processing subsystem with a closed-loop payment mechanism, and wants to use stored funds to pay for micromobility and other services outside of the closed-loop.

Integrating the micromobility management subsystem 107 with the universal hub 3C-01 then allows a universal hub user to plan, schedule, map and pay for multimodal journeys which involve micromobility vehicles. Similarly, the integration enables users who have accounts with the micromobility services provider associated with micromobility management subsystem 107 to plan, schedule, map and pay for multimodal journeys across multiple transportation systems.

In other embodiments, the micromobility management subsystem 107 implements the above-described universal hub internally. An example embodiment is shown in FIG. 3D. In FIG. 3D: micromobility management subsystem 107 is integrated with transportation processing subsystems 3D-03 and 3D-05 using, for example, APIs such as API 241. Then, micromobility management subsystem 107 implements universal hub 3D-01 internally to enable the above-described functionalities.

In some embodiments, universal hub 3C-01 and 3D-01 are implemented using hardware. In yet other embodiments, universal hub 3C-01 and 3D-01 are implemented using software. In yet other embodiments, universal hub 3C-band 3D-01 are implemented using a combination of hardware and software.

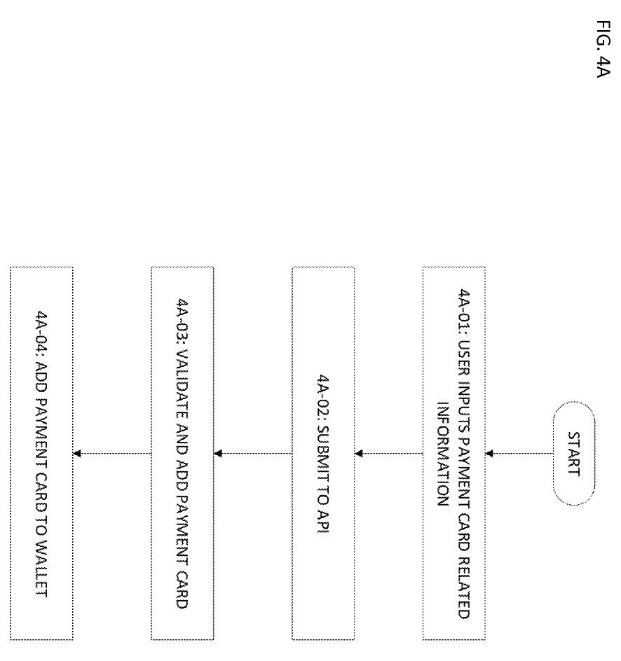

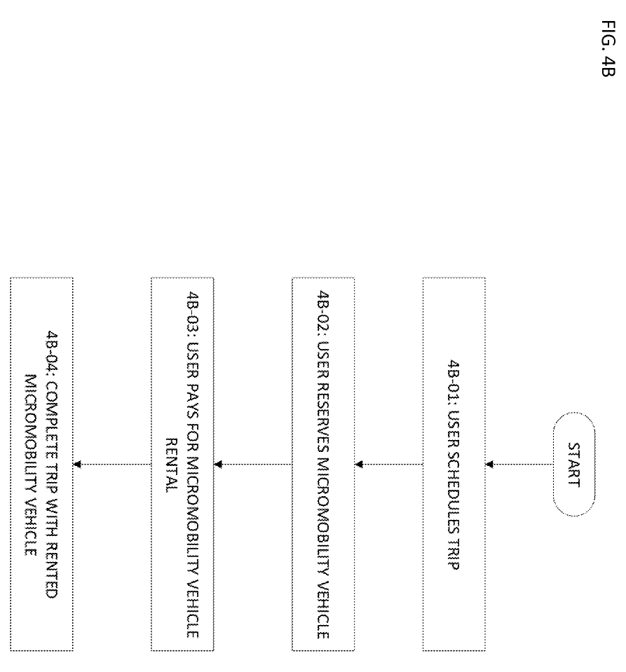

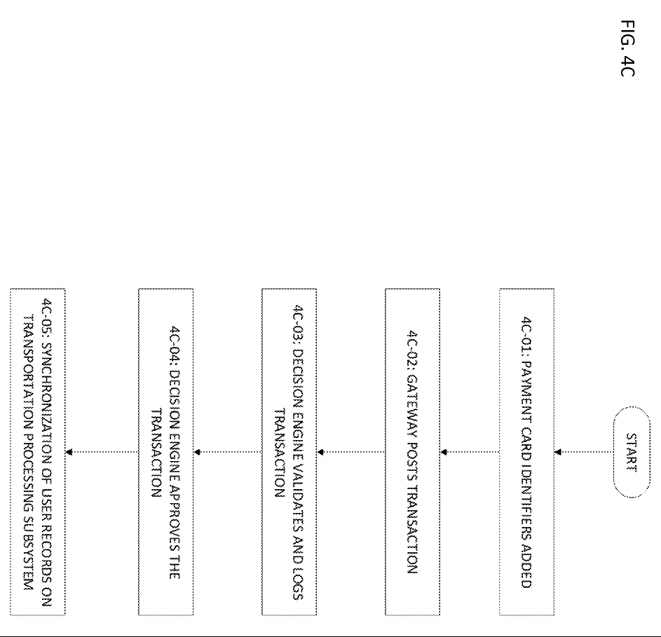

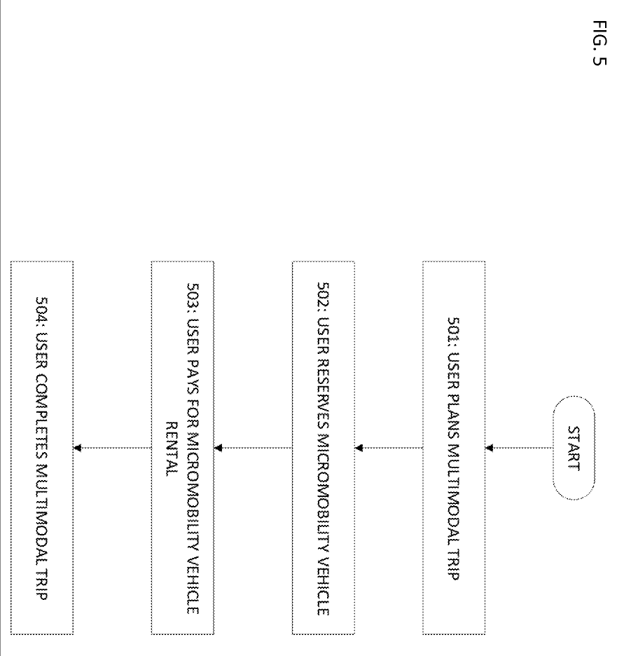

Example processes for the operation of system 100 are illustrated in FIGS. 4A, 4B, 4C and 5 and with reference to FIGS. 1, 2, 3A and 3B. In some embodiments, user 101 performs some of the functions involved in the processes using, for example, dashboards and interfaces presented on display 201-3 as part of the operation of application 201-4 or browser 201-9.

FIG. 4A shows an example embodiment of a process for a new user to validate and add a payment card. In step 4A-01, the user such as user 101 inputs the payment card related information using, for example, user device 103. This comprises, for example, card metadata, verification codes and expiry dates. In some embodiments, this is performed using, for example, application 201-4 on user device 103 or from a website via browser 201-9 on user device 103. In yet other embodiments, this is performed using an appropriate endpoint.

In step 4A-02, the information input in step 4A-01 is submitted to API 241 via network 105. In some embodiments, this is facilitated by payment subsystem 243.

In step 4A-03, validation unit 3B-01 of API 241 validates the payment card. In some embodiments, this is performed using third party systems 108, such as a third-party digital identity verification service, or in conjunction with a system provided by an external financial institution. In some embodiments, when the payment card is associated with the transportation system associated with transportation processing subsystem 109, validation unit 3B-01 works together with transportation processing subsystem 109 to perform the validation. In yet other embodiments, validation unit 3B-01 works together with one or more components of micromobility management subsystem 107. In further embodiments, the validation comprises user 101 working together with, for example, application 201-4 on user device 103 or a website via browser 201-9 on user device 103 to provide further inputs or perform further operations. In some embodiments, these operations comprise 2FA-related or MFA-related operations as described above. As explained above, in some embodiments, when an outcome of an operation which form part of the validation process such as the identity verification process is negative, then the entire process terminates.

In step 4A-04, the validated payment card data is added to, for example, a user wallet or user account within database 232 of micromobility management subsystem 107. Then, the user 101 can check the balance whenever needed using, for example, application 201-4 or browser 201-9 running on user device 103. User 101 can also check the balance from, for example, a payment terminal associated with transportation processing subsystem 109.

FIG. 4B shows an example process for renting a micromobility vehicle within a single-mode trip. In step 4B-01, user 101 utilizes user device 103 to schedule a trip with a rented micromobility vehicle. This is performed using, for example, application 201-4 or a website running on browser 201-9.

In step 4B-02, user 101 reserves a micromobility vehicle such as micromobility vehicle 113 through the micromobility management subsystem 107. In some embodiments, this is performed using user device 103, utilizing, for example, application 201-4 or a website running on browser 201-9.

In step 4B-03, user 101 pays for the rental. In some embodiments, user 101 utilizes user device 103 to make a payment using, for example, a digital wallet or a payment card or an application. In some embodiments, user 101 swipes or taps a payment card on a payment device associated with the micromobility service provider and communicatively coupled to micromobility management subsystem 107. In yet other embodiments, inputs provided during the payment process are provided to payment subsystem 243 via network 105.

In some of the embodiments where the micromobility management subsystem 107 is integrated with transportation processing subsystem 109, the user 101 pays for the rental using the payment mechanism which is part of transportation processing subsystem 109. For example, a SCOOTY user pays to rent a SCOOTY vehicle using the METROLINX PRESTO system as discussed previously.

An example embodiment of payment using a payment mechanism which is part of the transportation processing subsystem 109 when it is integrated with the micromobility management subsystem 107 is shown in FIG. 4C.

In step 4C-01, when a user such as user 101 initiates a payment by, for example, swiping or tapping a payment card, or using an application on a device such as user device 103; then payment card identifiers and a timestamp related to a transaction is sent to API gateway 3B-03 via, for example network 105 and, for example, payments subsystem 243. In some embodiments, the payment card is a closed-loop payment card.

In step 4C-02, gateway 3B-03 posts the transaction. In yet other embodiments, this is performed in conjunction with one or more of payments subsystem 243, micromobility processing subsystem 230-1 to 230-N, and database 232.

In step 4C-03, decision engine 3B-05 validates and logs the transaction. In some embodiments the validating comprises the decision engine 3B-05 working together with, for example, payments subsystem 243, micromobility processing subsystems 230-1 to 230-N, and database 232 or other components of system 100. In yet other embodiments, the validating comprises performing a 2FA or an MFA. In yet other embodiments, this comprises determining that the user 101 has sufficient funds to make the payment.

In step 4C-04, decision engine 3B-05 approves the transaction. In some embodiments, the approval is based on the validating performed in step 4C-03.

In some embodiments where there is integration with transportation processing subsystem 109 and there is a closed loop payment subsystem implemented by the transportation processing subsystem 109: the API synchronizes with the transportation processing subsystem 109 to, for example, update or synchronize records related to user 101 which are stored on transportation processing subsystem 109. This is shown in step 4C-05 of FIG. 4C.

In step 4B-04, user 101 commences the trip by, for example, using user device 103 to scan a QR code that the rented micromobility vehicle is equipped with; and completes the trip with the rented micromobility vehicle. Then, signals comprising information related to commencement of the trip are sent from user device 103 via, for example, network 105 to micromobility management subsystem 107 to indicate commencement of the trip. At completion of the trip, the user 101 parks the rented vehicle at a transit hub. Then, signals comprising information related to completion of the trip are sent from user device 103 via, for example, network 105 to micromobility management subsystem 107 to indicate completion of the trip. A summary of the trip is generated and saved in, for example database 232 of micromobility management subsystem 107 for access by user 101. In some embodiments, this summary is stored in an account related to user 101.

FIG. 5 shows an example process for renting one or more micromobility vehicles within a multimodal or multimode trip. In step 501 the user plans the journey using micromobility management subsystem 107, which interacts with, for example, transportation processing subsystem 109 to plan the journey.

In step 502, the user 101 reserves one or more micromobility vehicles such as micromobility vehicle 113 for each leg of the trip involving the use of a micromobility vehicle. The reservation request is made by user 101 utilizing user device 103 through, for example, one of application 201-4 or a website accessed using browser 201-9. The reservation request is fulfilled by, for example, the one or more micromobility processing subsystems 230-1 to 230-N and database 232 of micromobility management subsystem 107.

In step 503, the user pays for the micromobility vehicle rental. In some embodiments where the micromobility rental service is integrated with other transportation systems, the user 101 pays for the rental using the payment mechanism of the other transportation system. For example, a SCOOTY user pays to rent a SCOOTY vehicle using METROLINX PRESTO as discussed previously. An example process is shown in FIG. 4C, which has been described previously.

In step 504, the user completes the multimodal trip, including the one or more legs where a micromobility vehicle 113 is used. Processes to commence and complete each of these one or more legs have been previously disclosed above. A summary of the trip is generated and saved in, for example, database 232 of micromobility management subsystem 107 for access by user 101.

The processes presented in FIGS. 4A, 4B, 4C and 5 are example embodiments. Other embodiments and variations are possible. For example, in some embodiments, the user pays for the rental at the same time as reserving the micromobility vehicle. In other embodiments, payment is made after the trips are completed.

While the micromobility management subsystem 107 as described above performs functions related to micromobility vehicle rentals or shared micromobility vehicle services, one of ordinary skill in the art would appreciate that the micromobility management subsystem 107 could be generalized to manage services for other transit such as:

on-demand transit services such as RIDECO, VIA and ARGO,

ridesharing services such as UBER®, LYFT® and HOPP®, and

shared car and electric vehicle rental services such as TURO and COMMUNAUTO.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well-known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A system to integrate a first payment subsystem and a second payment subsystem, wherein:
the first payment subsystem is associated with a transportation processing subsystem,
the second payment subsystem is associated with a micromobility management subsystem, and
the micromobility management subsystem and transportation processing subsystem are communicatively coupled with each other via a network;
the system comprising:
an application programming interface (API) communicatively coupled to the micromobility management subsystem and the transportation processing subsystem, further wherein the API comprises:
a validation unit,
a gateway, and
a decision engine communicatively coupled to each other;
the gateway receives one or more payment card identifiers and a timestamp related to a transaction;
the gateway posts the transaction;
the decision engine validates the transaction; and
the decision engine either approves or rejects the transaction based on the validating.

2. The system of claim 1, wherein the first payment subsystem is a closed-loop payment subsystem.

3. The system of claim 1, wherein the one or more payment card identifiers are associated with a closed-loop payment card.

4. The system of claim 1, wherein:
the micromobility management subsystem comprises one or more micromobility processing subsystems; and
the decision engine works together with the one or more micromobility processing subsystems to perform the validating and logging.

5. The system of claim 3, wherein:
the micromobility management subsystem comprises a database;
the database comprises a user wallet associated with a user; and
the closed-loop payment card is added by the validation unit to the user wallet.

6. The system of claim 5, wherein:
a user device associated with the user is communicatively coupled to the API via the network;
the API receives information related to the closed-loop payment card from the user device;
the validation unit validates the closed-loop payment card using the received information; and
the validation unit adds the closed-loop payment card to the user wallet based on the validating.

7. The system of claim 6, wherein:
the information related to the closed-loop payment card comprises at least one of:
metadata related to the closed-loop payment card,
one or more verification codes, and
one or more expiry dates.

8. The system of claim 6, wherein the information related to the closed-loop payment card is received via:
either an application running on the user device, or
a browser running on the user device.

9. The system of claim 1, wherein the decision engine either approves or rejects the transaction based on an outcome of an identity verification process.

10. The system of claim 9, wherein the identity verification process is performed using data provided by a third party provider.

11. A method to integrate a first payment subsystem and a second payment subsystem, wherein:
the first payment subsystem is associated with a transportation processing subsystem,
the second payment subsystem is associated with a micromobility management subsystem, and
an application programming interface (API) communicatively coupled to the micromobility management subsystem and the transportation processing subsystem, further wherein the API comprises:
a validation unit,
a gateway, and
a decision engine;
the method comprising:
receiving, by the gateway, one or more payment card identifiers and a timestamp related to a transaction,
posting, by the gateway, the transaction,
validating, by the decision engine, the transaction, and
based on the validating, the decision engine either approves or rejects the transaction.

12. The method of claim 11, wherein the decision engine logs the transaction based on the validating.

13. The method of claim 11, wherein the first payment subsystem is a closed-loop payment subsystem.

14. The method of claim 11, wherein the one or more payment card identifiers are associated with a closed-loop payment card.

15. The method of claim 12, wherein:
the micromobility management subsystem comprises one or more micromobility processing subsystems; and
the decision engine works together with the one or more micromobility processing subsystems to perform the validating and logging.

16. The method of claim 14, wherein:
the micromobility management subsystem comprises a database;
the database comprises a user wallet associated with a user; and
the method comprises adding, by the validation unit, the closed-loop payment card to the user wallet.

17. The method of claim 15, further comprising:
receiving, by the API, information related to the closed-loop payment card;
validating, by the validation unit, the closed-loop payment card using the received information; and
adding, by the validation unit, the closed-loop payment card to the user wallet based on the validating.

18. The method of claim 17, wherein:
the information related to the closed-loop payment card comprises at least one of:
metadata related to the closed-loop payment card,
one or more verification codes, and
one or more expiry dates.

19. The method of claim 17, wherein the information related to the closed-loop payment card is received via:
either an application running on a user device, or
a browser running on the user device.

20. The method of claim 11, wherein the approval or rejection of the transaction is based on an outcome of an identity verification process.
